(19) United States
(12) Patent Application Publication
(10) Pub. No.: US 2009/0110472 A1
(43) Pub. Date: Apr. 30, 2009

(54) FLOATING PIN JOINT ASSEMBLY

(75) Inventors: Simon S. Liang, Aurora, IL (US); Ronald Mark Ginn, Morton, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR INC., Peoria, IL (US)

(21) Appl. No.: 11/931,841

(22) Filed: Oct. 31, 2007

(51) Int. Cl. F16C 11/00; E02F 3/00

(52) U.S. Cl. 403/151; 37/466

(57) ABSTRACT

A floating pin joint assembly pivotally connects a lift arm between spaced frame members. The lift arm includes a bushing with bearing surfaces supported on the pin for relative movement. Extending end portions of the pin are supported on bearing surfaces defined by collars connected to the frame members by inserts press fit into the frame members. Removable cover plates connected to the inserts contain the axial movement of the pin and permit removal of the pin and other components from the assembly. The load bearing surfaces are disposed within a lubricated chamber extending between the cover plates.

### TECHNICAL FIELD

This disclosure relates generally to pin joint assemblies with a floating pin employed to pivotally connect a lift arm or boom and spaced frame members. More particularly, it relates to such pin joint assemblies that include multiple, relatively slidable, load bearing surfaces within a lubricated environment.

### BACKGROUND

In machines with earth moving or material handling capabilities, such as wheel loaders, track loaders, backhoes and the like, pin joints are well known for attaching a lift arm or boom to the frame of the machine for utilization of a bucket or other implement. Pivotal joints employed in such heavy equipment typically include a yoke or spaced frame members that support a pivot pin, and a lift arm or boom positioned between the yoke, supported for oscillating movement relative to the pin.

Fixed pin arrangements include a pin constrained both axially and rotationally within the yoke. Such pins often experience fretting or galling making it difficult, or impossible to remove the pin without damage to the pin or associated elements.

Floating pin arrangements are also employed. Such pins are constrained axially, but allowed to rotate within the frame. These pins have no lubricated bearing support relative to the frame and also experience fretting and galling, as well as attendant removal difficulties.

More recently, sleeve bearing cartridge arrangements, fixed to the frame, have been employed that include freely rotatable bearing sleeves interposed between a pin, and the bushing of the pivotal arm. Such an arrangement is disclosed in United States Publication No. 2004/0228676 assigned to Caterpillar Inc.

In the sleeve bearing cartridge arrangement, the sleeves provide slidable load bearing surfaces between the sleeve outer surface and the arm bearing bushing and also between the sleeve inner surface and the outer surface of the pin. Important to the pivot pin function in such cartridge arrangements, the relatively slidable surfaces are disposed within a sealed, lubricated environment. The cartridge arrangement is intended to maximize the opportunity for relative sliding movement during oscillation between the arm and frame components to avoid fretting, galling or other destructive contact.

Elements such as the support joints of a boom on a vehicle frame experience heavy loading and operate in a high wear environment. Maintenance is often required, not only on the joint, but the supported components. Replacement of machine components or joint components is often compromised by the inability to disassemble the joint without destroying one or more of its components.

In cartridge type sleeve bearing assemblies, the cartridge bushing is press fit within the bore of the arm or boom. The pin includes collars at each end, press fit or otherwise fixed to the pin. The collars retain the bearing sleeves between the pin and bushing to form the cartridge. The cartridge is typically supported within the spaced frame members with collet or insert connections.

Even with use of sleeve bearing cartridges, removal efforts may result in damage to components, rendering them unusable. It is often necessary to cut the cartridge apart to accomplish removal, necessitating replacement. This result is particularly undesirable when the removal is dictated by the need to repair or replace elements other than the joint itself.

### BRIEF SUMMARY

The disclosure describes, in one aspect, a floating pin joint assembly to connect a first member to a second member in relative pivotal relation, the assembly comprising an axially elongate annular bushing having an inner cylindrical surface extending between radial annular ends, an axially elongate pin having a length between ends exceeding the axial length of the bushing, the pin having an outer cylindrical surface positioned within the inner cylindrical surface of the bushing and defining extending end portions, annular collars, each said collar having an inner axial surface defining a bearing surface surrounding an extending end portion of the pin, the inner cylindrical surface of the bushing and the bearing surfaces of the collars having a diameter larger than the diameter of the outer cylindrical surface of the pin and defining a load bearing interface with the outer cylindrical surface of the pin.

In another aspect the disclosure describes a floating pin joint assembly connecting, in relative pivotal relation, a first member including a pair of spaced frame members defining aligned bores, and a second member disposed between the spaced frame members and defining an elongate bore aligned with the aligned bores of the spaced frame members, the pin assembly including an axially elongate annular bushing having an outer cylindrical surface and an inner cylindrical surface extending between radial annular ends with said outer cylindrical surface retained in the elongate bore of the second member by interference fit, an axially elongate pin having a length between ends exceeding the axial length of the bushing, the pin having an outer cylindrical surface positioned within the inner cylindrical surface of the bushing and defining extending end portions, annular collars, each of the collars having an inner axial surface defining a bearing surface surrounding an extending end portion of the outer cylindrical surface of the pin, the inner cylindrical surface of the bushing and the bearing surfaces of the collars having a diameter larger than the diameter of the outer cylindrical surface of the pin, and defining a load bearing interface with the outer cylindrical surface of the pin.

Yet in another aspect, the disclosure describes a machine having a front portion defining spaced frame members having aligned bores and a lift arm disposed between the spaced frame members and having a bore aligned with the aligned bores of the spaced frame members, a floating pin joint assembly connecting the lift arm to the spaced frame members in relative pivotal relation, the floating pin assembly including an axially elongate annular bushing having an outer cylindrical surface and an inner generally cylindrical surface extending between radial annular ends with said outer cylindrical surface retained in the elongate bore of the lift arm by interference fit, an axially elongate pin having a length between ends exceeding the axial length of the bushing, the pin having an outer cylindrical surface positioned within the inner cylindrical surface of the bushing and defining extending end portions, annular collars having an inner axial surface defining a bearing surface surrounding an extending end portion of the outer cylindrical surface of the pin, the inner cylindrical surface of the bushing and the bearing surfaces of the collars having a diameter larger than the diameter of the outer cylindrical surface of the pin, and defining a load bearing interface with the outer cylindrical surface of the pin.

### BRIEF DESCRIPTION OF THE DRAWINGS

FIG. 1 is a side view of a wheel loader with a floating pin joint assembly connecting a lift arm to the non-engine end frame.

FIG. 2 is a perspective view of the floating pin joint assembly.

FIG. 3 is a plan view, in section, of the floating pin joint assembly taken along the line 3-3 of FIG. 1.

FIG. 4 is an end view of one of the collars of the floating pin joint assembly of FIG. 3.

FIG. 5 is a fragmentary sectional side view of the collar of FIG. 4 taken along line 5-5 of FIG. 4.

FIG. 6 is an end view of one of the sleeves of the pin joint assembly of FIG. 3.

FIG. 7 is a fragmentary sectional side view of the sleeve of FIG. 6 taken along the line 7-7 of FIG. 6.

FIG. 8 is a perspective view of a dowel of the floating pin joint assembly of FIG. 3.

### DETAILED DESCRIPTION

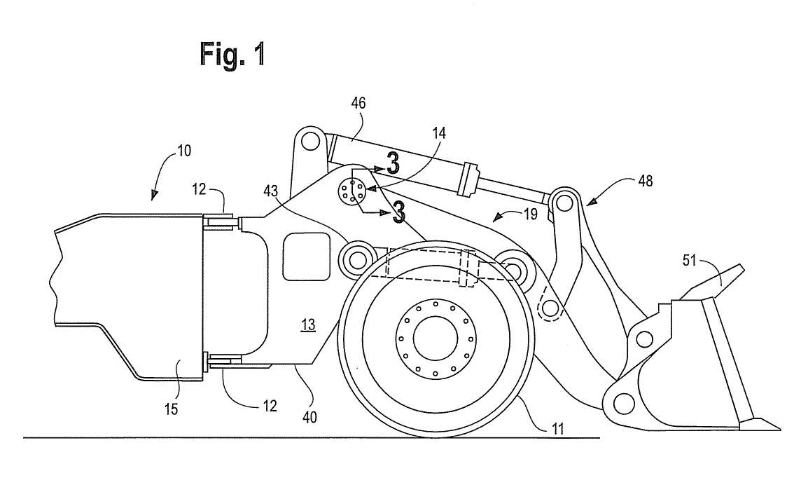

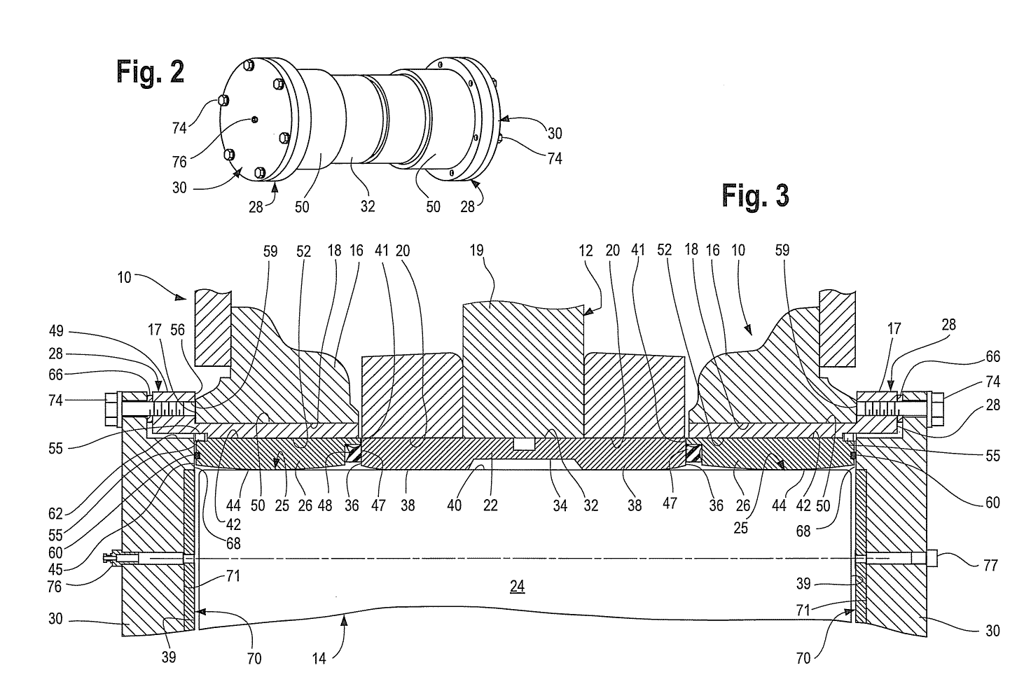

Referring now to the drawings and in particular to FIG. 1 a wheel loader is shown generally with reference 10. It should be understood, however, that many other types of equipment such as backhoes, excavators, material handlers and the like that include pivotal linkage arrangements can utilize the floating pin joint assembly described herein.

Wheel loader 10 has a structural frame with a front or non-engine end portion 13 and a rear or engine end portion 15. A plurality of ground supporting members 11 (wheels) one of which is shown, are connected to the front portion 13 and the rear portion 15 of the structural frame through axles, drive shafts or other components (not shown). A hitch arrangement pivotally connects the front portion 13 to the rear portion 15 by way of a pair of hinge joints 12.

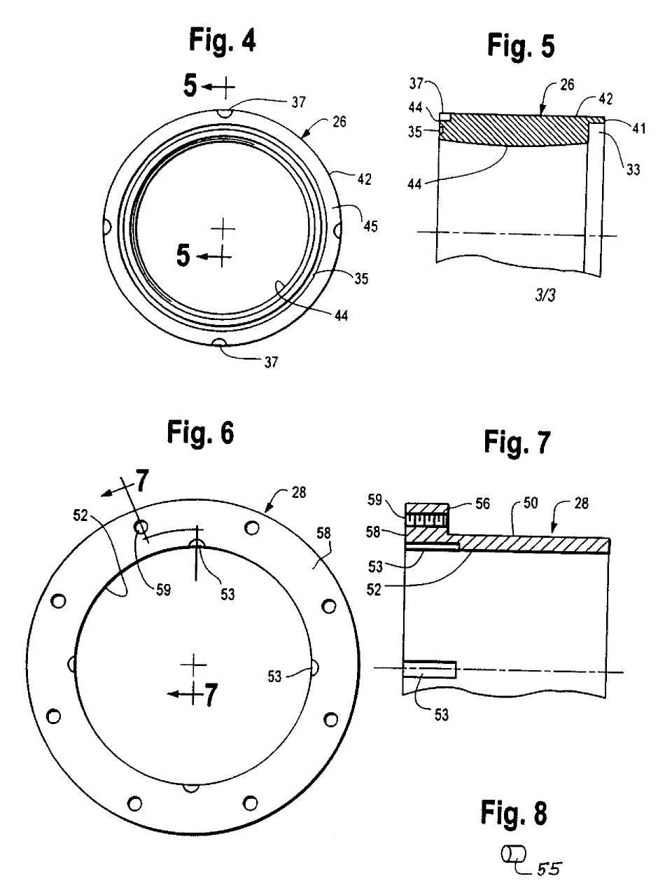

The front portion 13 of the frame defines a first member, including spaced frame members or flanges 16, best seen in FIGS. 3 and 4. A second member, in the form of a lift arm assembly or boom 19, is pivotally connected to the front portion 13 of the frame at flanges 16 by a floating pin joint assembly 14.

A lift cylinder 43 is pivotally connected between the front portion 13 of the frame and the lift arm assembly or boom 19. A tilt cylinder 46 is connected between the front portion 13 and a linkage arrangement 48. The boom 19, the lift cylinder 43, the tilt cylinder 46 and the linkage arrangement 48 raise, lower and angle an attached implement 51, such as a bucket, during loading and unloading operations.

Referring to FIG. 3, floating pin joint assembly 14 pivotally connects lift arm 19 to spaced frame members or walls 16. Frame members 16 include outer wall surfaces 17 and define aligned bores 18. Arm 19 defines an elongate bore 20 aligned with bores 18. Pin assembly 14, disposed in aligned bores 18 and 20, supports arm 19 between spaced frame members 16 for relative oscillatory movement.

Floating pin joint assembly 14 includes annular bushing 22, axially elongate pin 24, a pair of collars 26, a pair of inserts 28 and a pair of cover plates or retainers 30. These components may be made of suitable material such as steel. Collars 26 and inserts 28 are hardened steel.

Bushing 22 is axially elongate and includes an outer cylindrical surface 32 and inner generally cylindrical surface 34 extending between radial annular ends 36. Outer cylindrical surface 32 is sized to be retained within bore 20 of arm 19 by interference, or press fit.

As illustrated, inner generally cylindrical surface 34 of bushing 22 defines axially extending bearing surfaces 38 adjacent each end 36. These bearing surfaces are formed on a diameter smaller than the inner cylindrical surface 32, between the bearing surfaces.

Pin 24 is generally cylindrical, and defines outer cylindrical surface 40. It has an axial length between ends 39 that exceeds the axial length of bushing 22 between its ends 36. Its length, between ends 39, is about the same as the axial distance between the outermost surfaces 17 of frame members 16. The outer cylindrical surface 40 of pin 24 that extends axially beyond the ends 36 of elongate bushing 22 to the ends 39 of the pin define extending end portions 25.

Outer cylindrical surface 40 of pin 24 is formed on a diameter somewhat smaller than the diameter of inner cylindrical bearing surfaces 38 of bushing 22. Bushing 22 is supported by bearing surfaces 38 for oscillating movement upon the outer cylindrical surface 40 of pin 22. The areas of contact of surfaces 38 against outer cylindrical surface 40 of pin 24 represents the load bearing interface between bushing 22 and pin 24.

Each annular collar 26 of pin assembly 14 best seen in FIGS. 4 and 5, includes an axially inner radial annular wall 41, an axially outer radial annular wall 45, an outer axial cylindrical surface 42 and an inner axial surface 44. Axial outer cylindrical surface 42 of each annular collar is formed on a diameter that is about the same as the diameter of the outer cylindrical surface 32 of bushing 22.

As illustrated, inner axial surface 44 is a bearing surface and has an axial cross section that is convex toward extending end portions 25 of outer cylindrical surface 40 of pin 24. The minimum diameter of the convex surface 42 is about the same as the diameter of the bearing surfaces 38 of bushing 22. The areas of contact of surfaces 44 with outer cylindrical surface 40 of pin 24 at the extending end portions 25 represent the load bearing interface between pin 24 and collars 26.

The axially inner radial annular walls 41 of each collar 26 include a relief 33 which houses a seal assembly 47. Each seal assembly 47 provides a fluid tight seal between the axially inner radial annular wall 41 of each collar 26 and the ends 36 of bushing 22.

The axial outer radial annular walls 45 of each collar 26 include a counter bore 35 that houses a seal in the form of O-ring 60.

The outer axial cylindrical surface 42 of each collar includes a plurality of semi-cylindrical cut-outs 37 that intersect the axial outer radial annular wall 45. These cut-outs are equally spaced about the outer axial cylindrical surface 42.

Inserts 28 are generally annular, and include an axial, generally cylindrical portion and a radially directed ring portion.

The axial cylindrical portion of each insert includes an outer axial cylindrical surface 50 and an inner axial cylindrical surface 52. Axially outer cylindrical surface 50 is sized to be retained by interference fit within one of the aligned bores 18 in frame members 16 which fixes the inserts 28 against movement relative to the frame members 16.

Inner axial cylindrical surface 52 is sized to receive outer axial cylindrical surface 42 of a collar 26 in a slip fit relation. Each insert 28 includes a plurality of axial semi-cylindrical slots 53 about inner axial cylindrical surface 52. The slots 53 align with the semi-cylindrical cut-outs in outer axial cylindrical surface 42 of collars 26.

Cylindrical dowels 55 best seen in FIG. 8, are disposed in the cylindrical pocket defined by the semi-cylindrical cut-outs 37 in collars 26 and semi-cylindrical slots 53 in inserts 28. The dowels, made of suitable material such as steel, lock these components against relative rotation.

The radially directed ring portion of each insert 28 has an axially inner radial annular surface 56 and an axially outer radial annular surface 58. Each ring portion is provided with a plurality of threaded apertures 59 formed upon a bolt circle larger than the diameter of bores 18 of frame members 16.

Cover plates or retainers 30 are generally disc shaped. Each includes a peripheral relief. The relief, defined by axial cylindrical surface 62 and radial annular surface 64 overlies the ring portion of associated insert 28.

Each cover plate 30 includes a plurality of bolt holes aligned with threaded apertures 59 of inserts 28. Bolts 74 secure each cover plate 30 to one of the inserts 28. In the embodiment illustrated, eight (8) bolts are illustrated. The number, however, will vary depending on the loads experienced in a given application of the pin joint assembly.

One or more metal shims 66 are disposed between the axially outer radial annular surface 58 of inserts 28 and radial annular surface 64 defining peripheral relief on cover plate or retainer 30. The number of shims used varies. The shims 66 provide for accurate spacing of the retainers 30 relative to the ends 39 of pin 24 and accommodate variations in the distance between wall surfaces 17. Shims 66 are commonly used in pivot pin assemblies to set the overall axial spacing of the assembled components within the joint to assume proper operational relationships.

Each cover plate 30 also includes an inner generally planar surface 68 having a counter bore in which is disposed a thrust bearing disc 70. The inner planar surfaces 71 of the thrust bearing discs 70 are spaced apart slightly greater than the length of pin 24 between ends 39. The thrust bearings receive axial thrust forces on pin 24 through contact with an end 39 of pin 24.

The thrust bearings are formed out of any suitable material such as in a compressed power metallurgy material with requisite porosity to retain lubricant. The pin assembly 14 normally contains an oil or grease lubricant added during assembly.

The cover plates 30 and thrust bearing discs 70 include a central bore. One is provided with a lubrication valve 76 which permits replenishment of lubricant. The other includes a relief valve 77 that permits complete filing of lubricant into the assembly.

The seal assemblies 47 and O-ring seals 60 contain lubricant within the pin chamber defined by the bushing 22 collars 26 and cover plates 30. The sealed interface between the axially inner radial annular walls 41 of collars 26 and the radial annular ends 36 of bushing 22 and the sealed interface between the axially outer radial annular walls 45 of collars 26 and the inner generally planar surface 68 of cover plates 30 create a sealed chamber that extends between the plates 30 and encompasses all relatively slidable surfaces. All load bearing, relatively slidable, surfaces are therefore disposed within a lubricated environment.

Assembled floating pin joint assembly 14 supports lift arm 19 between frame members 16 for oscillatory movement. It includes bushing 22 press fit within bore 20. Bearing surfaces 38 of bushing 22 are supported upon outer cylindrical surface 40 of pin 24.

In the illustrated embodiment, collars 26 are retained in inserts 28 along the interface of outer axial cylindrical surface 42 of each collar 26 and inner axial cylindrical surface 52 of each insert 28 by dowels 55. The cylindrical dowels are positioned in the aligned semi-cylindrical cut outs and slots to fix the collars 26 against rotation relative to the inserts 28. The number of dowels employed varies and is determined by the operating torque in the pin joint. For example, in the embodiment illustrated four (4) dowels are contemplated between each collar 26 and insert 28. Other known arrangements to constrain the rotational movement of the collars 26 relative to the inserts 28 could be employed.

The inner axial surface 44 of each collar overlies an extending end portion of pin 24. Convex inner axial surface 44 of each collar 26 provides load bearing support for pin 24 at the extending end portions 25.

Inserts 28 are press fit into bores 18 of frame members 16 along the interface with outer axial cylindrical surface 50. Axially inner radial annular surface 56 of the ring portion of inserts 28 is urged into contact with outer wall surfaces 17 of frame members 16. Load delivered to the collars 26 from pin 24 is transferred to frame members 16 through inserts 28.

The inner planar surface 68 of each cover plate 30 overlies the semi-cylindrical cut-outs 37 at the outer axial cylindrical surface 42 of collars 26. This relationship retains the dowels 55 within the cut-outs and slots 53. Inner generally planar surface 68 also is urged against O-ring seal 60 in fluid tight sealing relation.

Disassembly of the pin joint assembly 14 is readily accomplished. One, or both of the covers 30 are removed. Pin 24 may then be slid axially out of the joint to separate the frame members 16 and lift arm 19. Also, with the covers 30 removed, the dowels 55 may be removed and the collars 26 slid out of the inserts 28.

Should more comprehensive disassembly be required, the inserts 28 may be urged axially out of the bores 18 in frame members 16. Similarly, bushing 22 may be urged axially out of the bore 20 of lift arm 19. Suitable hydraulic press equipment is available at initial assembly, or for field service to impart the necessary axial forces to these components.

### INDUSTRIAL APPLICABILITY

The present disclosure is applicable to pin joint assemblies for any oscillatory joint arrangement between relatively moveable components. Exemplary applications include a lift arm and end frame connection or a bucket and support arm connection of an end loader. The pin joint would also be suitable for other connections such as lift or tilt linkages.

The support of pin 24 within collars 26 on bearing surfaces 44 permits sliding movement of the pin 24 relative to the collars 26. The pin 24 is also slidable relative to bearing surfaces 38 of bushing 22. The arrangement thus provides multiple relatively slidable load bearing surfaces between the outer cylindrical surface 40 of pin 24, the inner cylindrical surface 34 of bushing 22 at bearing surfaces 38, and the bearing surfaces defined by inner axial surfaces 44 of collars 26. That is, the outer cylindrical surface 40 of pin 24 is rotatable relative to the bearing surfaces 38 of bushing 22 and inner axial surfaces 44 of collars 26. It is expected therefore that the interface that experiences the most lubrication, and consequently the lowest frictional forces, will also experience relative movement. That is, the bushing 22 will rotate relative to the pin 24 or the pin 24 will rotate relative to the collars 26. Such relative movement will replenish lubrication to the rotated surfaces.

The interface between the axially inner radial annular walls 41 of collars 26 and the radial annular ends of busing 22 is sealed by seal assemblies 47 and the interface between the axially outer radial annular walls 45 of collars 26 and the inner generally planar surface 68 of cover plates 30 is sealed by O-ring 60. These seals create a sealed chamber that extends between the cover plates 30 and encompasses all relatively slidable surfaces. The multiple, relatively slidable load bearing surfaces are axially spaced along the pin 40 all within a lubricated environment. This relationship maximizes relative sliding movement within the joint for the load bearing surfaces, between the bearing surfaces 38 and outer cylindrical surface 40 of pin 24 as well as the bearing surfaces 44 of collars 26 and the outer cylindrical surface 40 of pin 24.

The floating pin assembly 14 also permits disassembly without destruction of assembled components. Covers 30 are removed by removal of bolts 74. Pin 24 is then slidable axially out of the collars 24 and bushing 22 to separate the lift arm 19 from spaced frame members 16. The dowels 55 can be removed to permit removal of collars 26 from the inner axial cylindrical surfaces 52 of inserts 28. Inserts 28 and bushing 22 may be removed using suitable hydraulic press equipment.

Unworn parts can be reinstalled and reused as a cost savings. This is particularly true when separation was dictated by required repair to components other than the joint components.

The support of pin 24 within collars 26 and inserts 28 provides other advantages. For one, the press fit assembly of the inserts 28 into the bores 18 of frame member 16 eliminates any need for drilling or tapping attachment holes in the frame members 16. The inserts 28 also provide a hardened interface between the collars 26 and the bores 18 of frame member 16, reducing the occurrence of wear during operation. The inserts 28 also provide a serviceable component and eliminate the need to weld and remachine damaged bores 18 in frame member 16.

The invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A floating pin joint assembly to connect a first member to a second member in relative pivotal relation, said assembly comprising:
an axially elongate annular bushing having an inner cylindrical surface extending between radial annular ends,
an axially elongate pin having a length between ends exceeding the axial length of said bushing, said pin having an outer cylindrical surface positioned within said inner cylindrical surface of said bushing and defining extending end portions,
annular collars, each said collar having an inner axial surface defining a bearing surface surrounding an extending end portion of said pin,
said inner cylindrical surface of said bushing and said bearing surfaces of said collars having a diameter larger than said diameter of said outer cylindrical surface of said pin and defining a load bearing interface with said outer cylindrical surface of said pin and being rotatably slidable relative to said outer cylindrical surface of said pin.

2. A floating pin joint assembly as claimed in claim 1, wherein said collars each include an outer axial cylindrical surface, and said assembly further includes inserts, each of said inserts includes an inner axial cylindrical surface surrounding said outer axial cylindrical surface of one of said collars, with said collars supported in said inserts.

3. A floating pin joint assembly as claimed in claim 2 wherein said assembly further includes cover plates, and each one of said cover plates is removably secured to one of said inserts.

4. A floating pin joint assembly as claimed in claim 2 wherein said outer axial cylindrical surface of each said collar includes at least one semi-cylindrical cut-out,
said inner axial cylindrical surface of each said insert includes at least one semi-cylindrical slot aligned with said at least one cut-out in one of said collars, and, a dowel is disposed in each said aligned cut-out and slot.

5. A floating pin joint assembly as claimed in claim 3 wherein each said cover plate includes a thrust bearing disposed adjacent an end of said pin, wherein said inner cylindrical surface of said bushing includes a bearing surface adjacent each radial annular end and said inner axial surface of each said collar has an axial cross section that is convex toward an extending end portion of said outer cylindrical surface of said pin.

6. A floating pin joint assembly as claimed in claim 3 wherein each said collar includes an axially inner radial annular wall and an axially outer radial annular wall, and said cover plates each include an inner generally planar surface, a seal disposed between each said radial annular end of said bushing and an axially inner radial annular wall of one of said collars and a seal disposed between said axially outer radial annular wall of one of said collars and said inner generally planar surface of one of said cover plates.

7. A floating pin joint assembly as claimed in claim 6 wherein said outer axial cylindrical surface of each said collar includes at least one semi-cylindrical cut-out,
said inner axial cylindrical surface of each said insert includes at least one semi-cylindrical slot aligned with said at least one cut-out in one of said collars, and
a dowel disposed in each said aligned cut-out and slot.

8. A floating pin joint assembly as claimed in claim 6 wherein each said cover plate includes a thrust bearing disposed adjacent an end of said pin, wherein said inner cylindrical surface of said bushing includes a bearing surface adjacent each radial annular end and said inner axial surface of each said collar has an axial cross section that is convex toward an extending end portion of said outer cylindrical surface of said pin.

9. A floating pin joint assembly connecting, in relative pivotal relation, a first member including a pair of spaced frame members defining aligned bores and a second member disposed between said spaced frame members and defining an elongate bore aligned with said aligned bores of said spaced frame members, said pin assembly including:
an axially elongate annular bushing having an outer cylindrical surface and an inner cylindrical surface extending between radial annular ends with said outer cylindrical surface retained in said elongate bore of said second member by interference fit,
an axially elongate pin having a length between ends exceeding the axial length of said bushing, said pin having an outer cylindrical surface positioned within said inner cylindrical surface of said bushing and defining extending end portions,
annular collars each of said collars disposed within one of said aligned bores of one of said spaced frame members and supported therein, each of said collars having an inner axial surface defining a bearing surface surrounding an extending end portion of said outer cylindrical surface of said pin,
said inner cylindrical surface of said bushing and said bearing surfaces of said collars having a diameter larger than said diameter of said outer cylindrical surface of said pin, and defining a load bearing interface with said outer cylindrical surface of said pin and being rotatably slidable relative to said outer cylindrical surface of said pin.

10. A floating pin joint assembly as claimed in claim 9, wherein said collars each include an outer axial cylindrical surface, and said assembly further includes inserts, each of said inserts includes an inner axial cylindrical surface surrounding said outer axial cylindrical surface of one of said collars, with said collars supported in said inserts, each said insert including an outer axial cylindrical surface retained in one of said aligned bores of said spaced frame members by interference fit.

11. A floating pin joint assembly as claimed in claim 10 wherein said assembly further includes cover plates, and each one of said cover plates is removably secured to one of said inserts.

12. A floating pin joint assembly as claimed in claim 10 wherein said outer axial cylindrical surface of each said collar includes at least one semi-cylindrical cut-out,
said inner axial cylindrical surface of each said inserts includes at least one semi-cylindrical slot aligned with said at least one cut-out in one of said collars, and
a dowel is disposed in each said aligned cut-out and slot.

13. A floating pin joint assembly as claimed in claim 11 wherein each said cover plate includes a thrust bearing disposed adjacent an end of said pin, wherein said inner generally cylindrical surface of said bushing includes a bearing surface adjacent each radial annular end and said inner axial surface of each said collar has an axial cross section that is convex toward said extending end portion of said outer cylindrical surface of said pin.

14. A floating pin joint assembly as claimed in claim 11 wherein each said collar includes an axially inner radial annular wall and an axially outer radial annular wall, and said cover plates each include an inner generally planar surface, a seal disposed between each said radial annular end of said bushing and an axially inner radial annular wall of one of said collars and a seal disposed between said axially outer radial annular wall of one of said collars and said inner generally planar surface of one of said cover plates.

15. A floating pin joint assembly as claimed in claim 14 wherein said outer axial cylindrical surface of each of said collars includes at least one semi-cylindrical cut-out,
said inner axial cylindrical surface of each said insert includes at least one semi-cylindrical slot aligned with said at least one cut-out in one of said collars, and
a dowel disposed in each said aligned cut-out and slot.

16. A floating pin joint assembly as claimed in claim 15 wherein each said cover plate includes a thrust bearing disposed adjacent an end of said pin, wherein said inner generally cylindrical surface of said bushing includes a bearing surface adjacent each radial annular end and said inner axial surface of each said collar has an axial cross section that is convex toward said extending end portion of said outer cylindrical surface of said pin.

17. A machine having a front portion defining spaced frame members having aligned bores and a lift arm disposed between said spaced frame members and having a bore aligned with said aligned bores of said spaced frame members,
a floating pin joint assembly connecting said lift aim to said spaced frame members in relative pivotal relation, said floating pin assembly including:
an axially elongate annular bushing having an outer cylindrical surface and an inner generally cylindrical surface extending between radial annular ends with said outer cylindrical surface retained in said elongate bore of said lift arm by interference fit,
an axially elongate pin having a length between ends exceeding the axial length of said bushing, said pin having an outer cylindrical surface positioned within said inner cylindrical surface of said bushing and defining extending end portions,
annular collars each of said collars disposed within one of said aligned bores of one of said spaced frame members and supported therein, each of said collars having an inner axial surface defining a bearing surface surrounding an extending end portion of said outer cylindrical surface of said pin,
said inner cylindrical surface of said bushing and said bearing surfaces of said collars having a diameter larger than said diameter of said outer cylindrical surface of said pin, and defining a load bearing interface with said outer cylindrical surface of said pin and being rotatably slidable relative to said outer cylindrical surface of said pin.

18. A machine as claimed in claim 17, wherein said floating pin joint assembly further includes inserts, each of said inserts includes an inner axial cylindrical surface surrounding said outer axial cylindrical surface of one of said collars, with said collars supported in said inserts, each said insert including an outer axial cylindrical surface retained in one of said aligned bores of said spaced frame members by interference fit, and
wherein said assembly further includes cover plates, and each one of said cover plates removably is secured to one of said inserts.

19. A machine as claimed in claim 18 wherein said outer axial cylindrical surface of each said collar includes at least one semi-cylindrical cut-out,
said inner axial cylindrical surface of each said insert includes at least one semi-cylindrical slot aligned with said at least one cut-out in one of said collars, and
a dowel disposed is in each said aligned cut-out and slot.

20. A machine as claimed in claim 19 wherein each said collar includes an axially inner radial annular wall and an axially outer radial annular wall, and said cover plates each include an inner generally planar surface, a seal disposed between each said radial annular end of said bushing and an axially inner radial annular wall of one of said collars and a seal disposed between said axially outer radial annular wall of one of said collars and said inner generally planar surface of one of said cover plates.
